(19) United States
(12) Patent Application Publication
(10) Pub. No.: US 2010/0303614 A1
(43) Pub. Date: Dec. 2, 2010

(54) Energy Collection System

(76) Inventor: Norbert Hector, Browns Summit, NC (US)

Correspondence Address: COATS & BENNETT, PLLC, 1400 Crescent Green, Suite 300, Cary, NC, 27518, US

(21) Appl. No.: 12/474,621

(22) Filed: May 29, 2009

(51) Int. Cl. F03D 3/00; F03B 3/18

(52) U.S. Cl. 415/151

(57) ABSTRACT

A turbine assembly converts kinetic energy from a flowing fluid into electrical or mechanical energy. The turbine assembly includes a turbine and a vane assembly. The turbine has a plurality of vanes disposed on its circumference and rotates about a vertical axis responsive to the flowing fluid contacting the vanes. The vane assembly also rotates about the vertical axis, but does so independently of the turbine. The vane assembly rotates to direct the flowing fluid into contact with the vanes.

### FIELD OF THE INVENTION

The present invention relates to systems and devices that convert kinetic energy from a moving fluid, such as air or water, to electrical or mechanical energy.

### BACKGROUND

Many different devices are able to convert the kinetic energy collected from a moving fluid, such as air or water, into useful electrical or mechanical energy. A wind turbine that converts wind energy into electricity is one example of such a device. Wind turbines generally include a plurality of elongated blades or sails that face the oncoming wind. Air hitting the blades causes them to rotate about a common axis. This rotation, in turn, drives a generator that is connected to the wind turbine to produce electrical power. Similarly functioning devices can also be employed to convert flowing water into electricity.

Wind turbines can be categorized into one of two types based on whether the turbine rotates about a vertical axis or a horizontal axis. Each type is useful; however, both also have drawbacks. For example, turbines that rotate about a horizontal axis are generally disposed at the end of a tall pole that raises the wind turbine to a height where wind speeds are generally faster. Although the faster wind allows the wind turbine to produce more power, it also subjects the turbine to a greater possibility of structural damage. Additionally, the components of these devices, such as the blades or sails, are generally very large, and thus, make transportation, construction, and maintenance difficult and costly.

### SUMMARY

In one embodiment of the present invention, a turbine assembly generates electrical or mechanical energy from the kinetic energy of a flowing fluid. The turbine assembly comprises a horizontally-oriented turbine and a vane assembly, each of which rotates about the same vertical axis independently of the other. The turbine has a plurality of vanes disposed at substantially regularly-spaced intervals around its circumferential edge. In one embodiment, the vanes are formed as undulations. A fluid, such as air or water, for example, flows into contact with the vanes on the turbine. This contact causes the turbine to rotate about the vertical axis. A drive shaft interconnects the turbine and a generator, for example. The drive shaft rotates in the same direction with the turbine to drive the generator to produce electricity.

The vane assembly also rotates about the vertical axis, but does so independently of the turbine. The vane assembly has a pair of directional panels and a pair of deflector panels. The orientation of the deflector panels is adjustable such that they re-direct at least some potentially unproductive fluid flowing at the peripheral edges of the turbine into more productive contact with the vanes. Particularly, when the fluid flows toward the turbine assembly at a velocity that does not exceed a predetermined threshold velocity, the directional panels use the oncoming fluid flow to automatically re-position or orient the vane assembly such that the deflector panels face the direction of the oncoming fluid. However, when the velocity of the fluid flow exceeds the predetermined threshold velocity, the directional panels use the oncoming fluid flow to automatically re-position or orient the vane assembly at least partially away from the oncoming fluid to protect the turbine assembly from damage.

### BRIEF DESCRIPTION OF THE DRAWINGS

FIG. 1 is a perspective view of a Vertical Axis Cross-Flow Turbine (VACFT) system configured to convert wind energy to electrical energy according to one embodiment of the present invention.

FIG. 2 is a perspective view of some of the components of the VACFT according to one embodiment of the present invention.

FIGS. 3A-3B are perspective views illustrating how the deflector panels of the present invention operate according to one embodiment of the present invention.

FIG. 4 is another perspective view of the components of the VACFT according to one embodiment of the present invention.

FIG. 5 is a perspective view of the VACFT components configured according to another embodiment of the present invention.

FIG. 6 is a perspective view of the VACFT components configured according to another embodiment of the present invention.

### DETAILED DESCRIPTION

The present invention provides a Vertical Axis Cross-Flow Turbine (VACFT) device that captures the kinetic energy from a moving fluid, such as air or water, and converts that energy into useful mechanical and/or electrical energy. Devices constructed according to the present invention may be positioned alone, or at locations such as a “wind farm,” for example, with other wind collection devices. The VACFT of the present invention differs from prior art systems in that the VACFT includes a system that re-directs fluid, such as air or water, for example, towards a turbine. The re-direction system rotates independently of the turbine responsive to the changing direction of the fluid, and includes features that protect the turbine against structural damage.

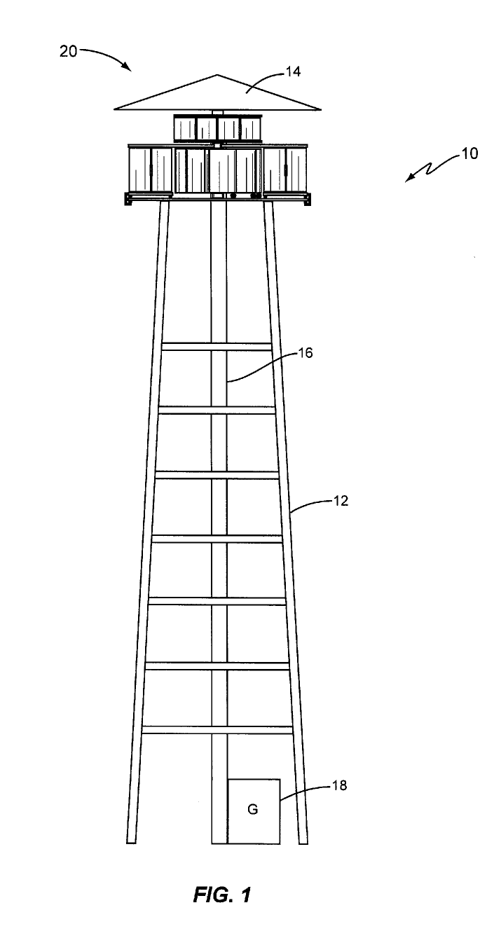

FIG. 1 illustrates a VACFT system 10 that is configured according to one embodiment of the present invention. As seen in FIG. 1, the VACFT system 10 comprises a support structure 12 that supports a turbine assembly 20 above a ground surface. A roof 14 may be positioned atop the turbine assembly 20 to protect the turbine assembly 20 and components thereof from the damaging effects of snow, ice, and other moisture that may degrade the useful lifespan of the turbine assembly 20. One end of an elongated rotary drive shaft 16 is mechanically coupled to the turbine assembly 20, while the opposite end of the drive shaft 16 couples to a generator 18 disposed at the bottom of the support structure 12. The purpose of the rotary drive shaft 16 is to transfer rotational energy from the turbine assembly 20 to the generator 18 such that the generator 18 produces electricity.

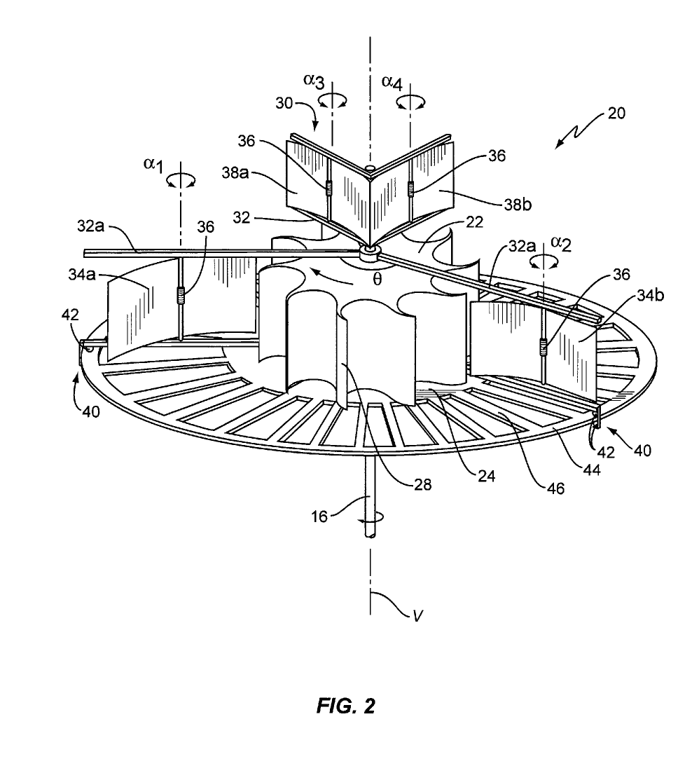

FIG. 2 illustrates the turbine assembly 20 in more detail. Particularly, the turbine assembly 20 includes a fluid-driven turbine 22 disposed to rotate about a vertical axis v. One of the functions of turbine 22 is to convert the kinetic energy from the flowing fluid into electrical or mechanical energy. Turbine 22 comprises a plurality of regularly-spaced, undulations or vanes 28 formed on its circumference. The vanes 28 are rigid and curved, and are sized and shaped to capture the wind blowing into the turbine assembly 20. Wind entering the turbine assembly 20 strikes the vanes 28 causing the turbine 22 to rotate about its vertical axis v. The drive shaft 16 is coupled to the turbine 22, and thus, rotates with the turbine 22 about the same vertical axis v. As stated above, the other end of the drive shaft 16 is coupled to the generator 18 using any known method. When the turbine 22 rotates, it causes the drive shaft 16 to rotate as well, which then drives the generator 18 to output an electrical current.

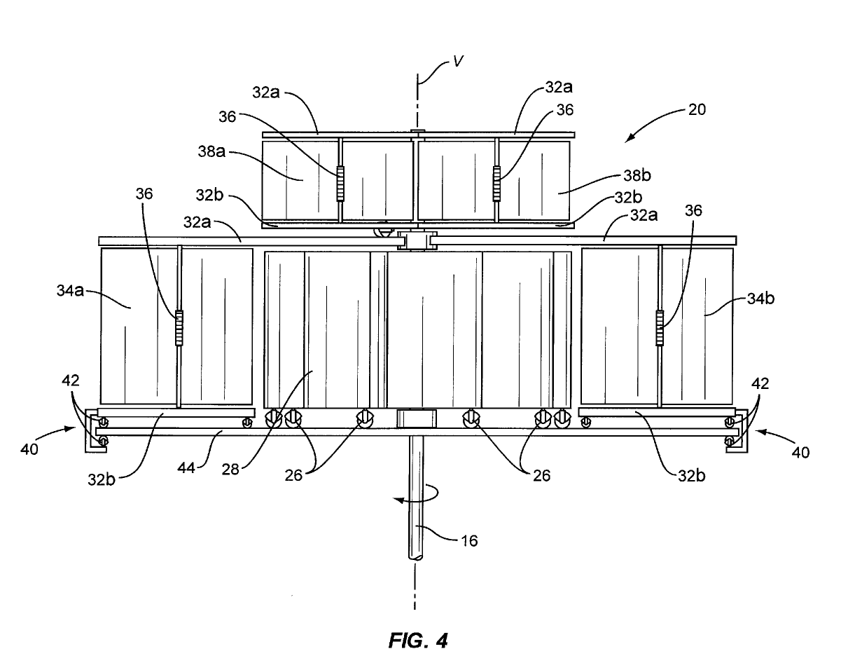

The turbine 22 is horizontally-oriented, and is mounted to, and at least partially supported by, the drive shaft 16. However, a plurality of wheels 26 (see FIG. 4) may also be disposed between a bottom surface of the turbine 22 and the top surface of an inner track or platform 24. The wheels 26 facilitate the turbine 22 rotating about the inner platform 24, and can provide support for turbine 22.

The turbine assembly 20 also includes a vane assembly 30. The vane assembly 30 is coupled to the turbine 22 such that it rotates 360° and independently of the turbine 22 about the vertical axis v responsive to the direction and/or force of the oncoming wind. The vane assembly 30 is equipped with a plurality of panels and performs multiple functions. First, the vane assembly 30 re-directs at least some potentially unproductive wind flowing at the peripheral edges of turbine 22 into more productive contact with the vanes 28. Second, the vane assembly 30 uses the oncoming wind to automatically re-position or “steer” or orient itself such that it faces the direction of the oncoming wind. Third, when the wind is moving at potentially dangerous velocities, the vane assembly uses the oncoming wind to orient itself away from the oncoming wind to protect the turbine assembly from damage. As described in more detail below, these functions allow the vane assembly 30 to direct an optimal amount of wind into more productive contact with the turbine 22 while protecting the VACFT 10 from potential damage due to high velocity winds. Optimizing the amount of wind that productively contacts the vanes 28 allows the turbine assembly 10 to drive the generator 18 more efficiently.

The vane assembly 30 comprises a support frame 32 that couples to the drive shaft 16, but pivots independently of both the drive shaft 16 and the turbine 22 about the vertical axis v. As seen in FIG. 2, the support frame 32 comprises a rigid pair of outwardly extending arms. Each arm has a rigid upper member 32a, and an opposing rigid lower member 32b. The arms extend outwardly from the axis v such that they form an angle θ. In this embodiment, the angle θ is an acute angle selected to optimize the amount of wind that will contact the vanes 28. However, those skilled in the art will appreciate that E may be any angle needed or desired. A caster assembly 40 is attached to the lower members 32b of each arm to allow the support frame 32 to travel on the surface of an outer support ring 44.

Each arm also comprises a deflector panel 34a, 34b that pivots about a respective vertical axis α₁, α₂. The deflector panels 34 are comprised of a rigid or semi-rigid material, and are approximately 18-36 inches in length; however, those skilled in the art will realize that the panels may be any length or size desired. The deflector panels 34 function to direct or channel wind approaching the turbine 22 towards the vanes 28. In one preferred embodiment, the deflector panels 34 are curved panels; however, a particular shape or curvature is not required. The deflector panels 34, or portions thereof, may have a substantially planar surface, for example. The deflector panels 34, in this embodiment, are positioned such that a peripheral edge of the deflector panel 34 is about 6 inches from the vanes formed on the turbine 22.

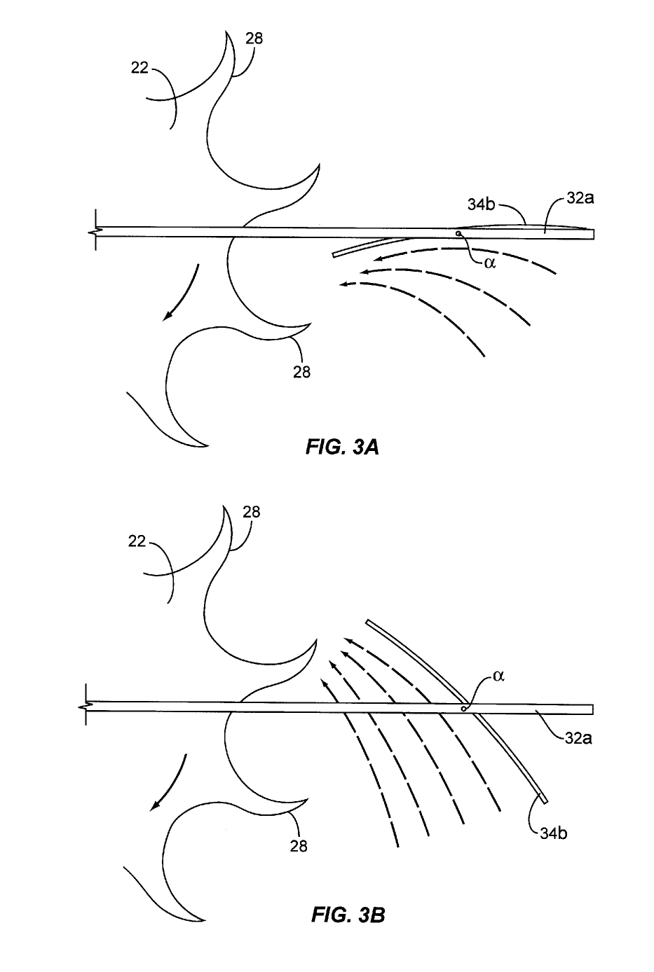

As seen in FIGS. 2 and 3, each deflector panel 34 is pivotably connected to the support frame 32 such that the deflector panels 34 move between a first position (FIG. 3A) and a second position (FIG. 3B). Each deflector panel 34a, 34b also includes a biasing member, such as a spring 36, for example, that pivots the deflector panel 34a, 34b between the first and second positions. The springs 36 are selected to normally bias their respective deflector panels 34 to the first position. In this first position, the deflector panels 34 direct an optimal amount of wind force onto the vanes 28 of turbine 22.

The springs 36 will maintain the deflector panels 34 in the first position so long as the velocity of the wind remains below a predetermined threshold velocity. However, when the wind velocity reaches or exceeds the predetermined threshold velocity, the springs 36 allow the deflector panels 34 to pivot to the second position. In the second position, at least some of the wind is permitted to flow past the deflector panels 34 to impact the turbine 22 in a manner that at least partially counteracts the rotation of the turbine 22. Although this may reduce the speed of the turbine 22, allowing the deflector panels 34 to pivot to the second position responsive to pre-selected wind velocities can prevent damage to the turbine assembly 20 and to the generator 18 caused by excessively high wind speeds. When the wind velocity subsides below the predetermined threshold velocity, the springs 36 bias their respective deflector panels 34 to the first position.

The vane assembly 30 also includes a pair of independent directional panels 38a, 38b attached to the support frame 32. In this embodiment, the directional panels 38 comprise rigid or semi-rigid curved panels constructed of the same or similar material as the deflector panels 34. However, the directional panels 38 may also be formed to have at least a partially planar surface. The directional panels 38 are positioned above a top surface of the turbine 22 and form a wedge. Together, the directional panels 38 are “V-shaped” to “steer” or orient the vane assembly 30 responsive to the changing wind direction to ensure that the area between the deflector panels 34 faces the oncoming wind. Specifically, as the wind strikes the directional panels 38, it causes the vane assembly 30 to rotate independently of the turbine 22 about the vertical axis v such that the open area between the deflector panels 34 faces the oncoming wind.

Each directional panel 38a, 38b is also pivotably attached to upper and lower frame members 32a, 32b, and includes a spring 36. As above, the spring 36 normally biases its respective directional panel 38 to the first position so long as the wind speed remains below a predetermined threshold velocity. However, once the wind speed reaches or exceeds the predetermined threshold velocity, the directional panels 38 overcome the biasing force of the springs 36 and pivot about corresponding vertical axes α₃, α₄ to the second position. This will allow the wind to blow at least partially through the directional panels 38. Although this will impinge on the ability of the directional panels 38 to orient the deflector panels 34 to face the wind, it will help to protect the turbine 22 from rotating at potentially harmful speeds.

Those skilled in the art will readily appreciate that the springs 36 used as biasing members in the directional panels 38 need not be the same types of springs 36 used to bias the directional panels 38. Each spring 36 on one or more of the panels 34, 38 may be the same or different, and each may be selected to pivot its corresponding panel 34, 38 between the first and second positions responsive to different, pre-selected threshold wind velocities.

In addition to these biasing mechanisms that help to protect the turbine assembly 20 from serious damage caused by high wind speeds, the present invention also uses another measure of protection. Particularly, wind can, at times, enter the turbine assembly 20 from the bottom of the support structure 12. At a sufficiently high velocity, such a wind could damage the turbine 22 and/or other components in the turbine assembly 20. To prevent such damage caused by uplift, the present invention provides a platform that allows at least some wind to pass through its bottom surface.

In this embodiment, a plurality of spaced planks or spokes 46 radially spans the distance between the inner track 24 and the outer concentric track 44. The spaces between the spokes 46 allow wind to pass through the turbine assembly 20 without lifting the turbine assembly 20 off of the support structure 12. In other embodiments, the spokes 36 may be replaced with a grate floor that allows wind to pass through.

In addition, the support frame 32 also includes another mechanism to protect the turbine assembly 20 against “uplift.” Specifically, each caster assembly 40 includes a pair of opposing wheels 42. A first wheel 42a of each pair is disposed above the surface of the outer track 44 and the second wheel 42b is disposed below the outer track 44. The second wheel 42b allows the support frame 32 to pivot about the vertical axis v, but also prevents “uplift” damage to the support frame 32 caused by wind striking the bottom of the turbine assembly 20.

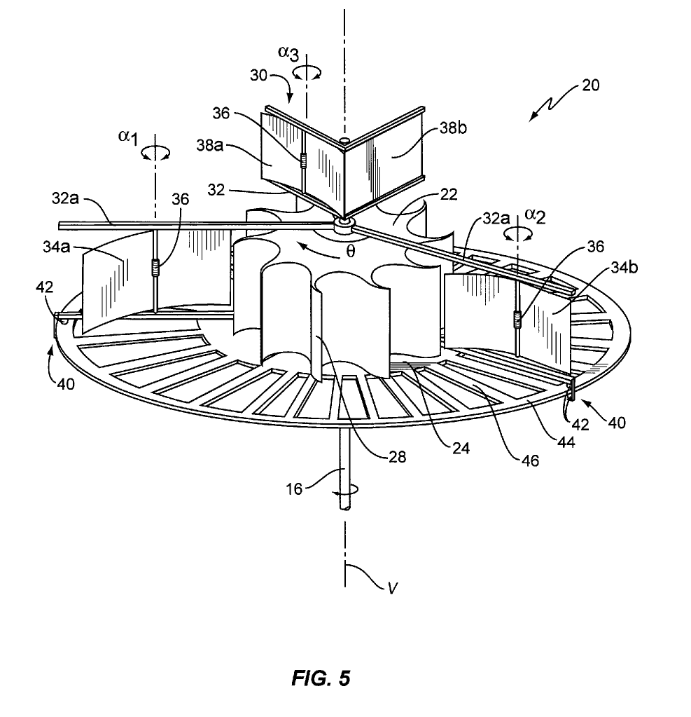

FIG. 5 illustrates the turbine assembly 20 configured according to another embodiment of the present invention. In this embodiment, only one of the directional panels 38a pivotably attaches to the support frame 32 such that it pivots between the first and second positions as previously described. The other panel 38b, however, is fixedly attached to the support frame 32 and does not pivot between the first and second positions. With this configuration, the directional panels 38 rotate the entire vane assembly 30 about the vertical axis v when the wind velocity is below the predetermined threshold velocity. As stated previously, this ensures that the deflector vanes 34 are appropriately positioned to re-direct an optimal amount of wind into contact with the turbine 22. However, when the wind exceeds that predetermined threshold velocity, the force of the oncoming wind contacting the fixed directional panel 38b rotates the entire vane assembly 30 about axis v such that the deflector panels 34 are positioned away from the oncoming wind. Rotating the entire vane assembly 30 away from the oncoming wind during periods of high wind velocities can help to protect the turbine assembly 20 and its components from possible damage.

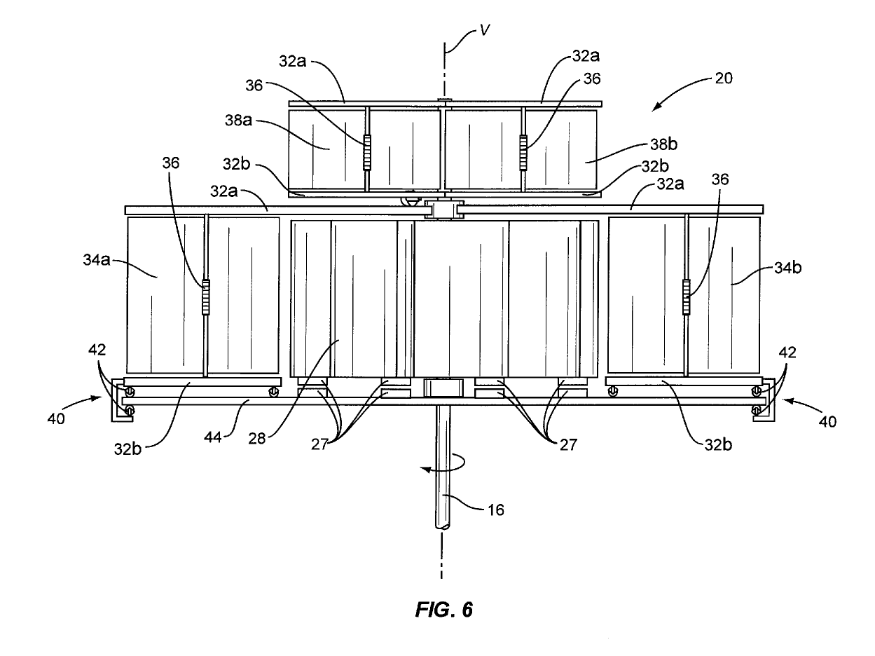

In the previous embodiments, the turbine 22 is described as rotating about the vertical axis v on wheels 26. However, FIG. 6 illustrates another embodiment of the present invention wherein the turbine 22 rotates on a magnetic field above the inner track or platform 24. Particularly, a first set of magnets 27 are disposed on an underside of the turbine 22 and a second set of magnets 27 are disposed on the surface of the inner platform 24. The first and second set of magnets are positioned such that the polarities of the magnets cause them to repel each other as the turbine 22 rotates about the vertical axis v.

The present invention may, of course, be carried out in other ways than those specifically set forth herein without departing from essential characteristics of the invention. For example, the previous embodiments disclose the present invention in terms of a wind-driven device. However, the VACFT 10 may also be employed to produce electrical or mechanical energy from water current. In one embodiment, for example, the VACFT 10 is positioned and horizontally-orientated in moving water such that the water current causes the turbine 22 to rotate. In these embodiments, the rotating turbine 22 would drive a generator 28 via drive shaft 16 to generate electrical power. Additionally, the vane assembly 30 and its panels 34, 38 would pivot as previously described to ensure that the maximum amount of flowing water contacts the vanes 28 of turbine 22. However, should the velocity of the current exceeds a preselected velocity, the panels 34, 38 and/or the vane assembly 30 would operate as previously described to help protect the turbine assembly 20 from potential damage.

Further, the previous embodiments illustrate the vane assembly has having a pair of directional panels 38 and a pair of deflector panels 34. However, this is simply for illustrative purposes. The turbine assembly 20 may include more or fewer than the illustrated number of directional panels 38, and more or fewer of the illustrated deflector panels 34. Some or all of the panels 34, 38 may be pivotably attached to the support frame 32 as previously described.

Additionally, the previous embodiments describe the present invention in terms of driving a generator to produce electrical power. Those skilled in the art, however, will realize that the present invention may also be used to perform a mechanical function in addition to, or instead of, generating electrical power. In one embodiment, for example, the turbine assembly is driven by a flowing fluid to operate a pumping mechanism. The pumping mechanism may be ultimately used in irrigation operations, or may be used to remove water or other fluids from flooded areas.

Accordingly, the present embodiments are to be considered in all respects as illustrative and not restrictive, and all changes coming within the meaning and equivalency range of the appended claims are intended to be embraced therein.

What is claimed is:

1. A turbine assembly for generating energy comprising:
a turbine including a plurality of circumferential vanes and configured to rotate about a vertical axis responsive to a flowing fluid; and
a vane assembly configured to rotate about the vertical axis independently of the turbine to direct the flowing fluid into contact with the vanes.

2. The turbine assembly of claim 1 further comprising an inner support track and a concentric outer support track.

3. The turbine assembly of claim 2 wherein the vane assembly comprises a first wheel that contacts an upper surface of the outer support rack and a second wheel that contacts an underside of the outer support track.

4. The turbine assembly of claim 1 wherein the vane assembly comprises one or more adjustable directional panels to orient the vane assembly towards the flowing fluid responsive to the flowing fluid.

5. The turbine assembly of claim 4 wherein at least one of the directional panels is pivotable between a first position and a second position.

6. The turbine assembly of claim 5 wherein the other of the directional panels is fixed to not pivot between the first and second positions.

7. The turbine assembly of claim 5 further comprising a selected biasing member associated with the at least one directional panel, and wherein the biasing member is selected to:
bias the at least one directional panel to the first position when a velocity of the flowing fluid is not greater than a predetermined velocity; and
allow the at least one directional panel to pivot to the second position when the velocity of the flowing fluid exceeds the predetermined velocity.

8. The turbine assembly of claim 1 wherein the vane assembly comprises one or more adjustable deflector panels positioned adjacent a circumferential edge of the turbine to direct the flowing fluid into contact with the vanes.

9. The turbine assembly of claim 8 wherein the vane assembly is configured to rotate about the vertical axis responsive to the flowing fluid to orient the one or more deflector panels to direct the flowing fluid into contact with the vanes.

10. The turbine assembly of claim 8 wherein the one or more deflector panels are pivotable between a first position and a second position.

11. The turbine assembly of claim 10 further comprising a selected biasing member associated with each of the one or more deflector panels, and wherein each biasing member is selected to:
bias its corresponding deflector panel to the first position when a velocity of the flowing fluid is not greater than a predetermined velocity; and
allow its corresponding deflector panel to pivot to the second position when the velocity of the flowing fluid exceeds the predetermined velocity.

12. The turbine assembly of claim 1 wherein the vane assembly further comprises a support frame that pivots about the vertical axis independently of the turbine.

13. The turbine assembly of claim 12 wherein the vane assembly comprises one or more directional panels pivotably attached to the support frame above the turbine, and one or more deflector panels pivotably attached to the support frame adjacent a circumferential edge of the turbine.

14. The turbine assembly of claim 13 wherein one or more of the directional panels and the deflector panels pivot between a first position and a second position based on whether a velocity of the flowing fluid exceeds a predetermined velocity.

15. The turbine assembly of claim 1 further comprising a support structure to raise the turbine above a ground surface.

16. The turbine assembly of claim 1 further comprising a drive shaft that interconnects the turbine and a generator that converts the rotational energy of the turbine into one of electrical energy and mechanical energy.

17. The turbine assembly of claim 1 wherein the flowing fluid is air.

18. The turbine assembly of claim 1 wherein the flowing fluid is a liquid.
